(19) United States
(12) Patent Application Publication
(10) Pub. No.: US 2026/0196927 A1
(43) Pub. Date: Jul. 9, 2026

(54) LOW VOLTAGE SIDE PRECHARGE CIRCUITRY

(71) Applicant: AMPERESAND PTE LTD., Singapore (SG)

(72) Inventors: Hlaing WIN, SINGAPORE (SG); Abishek SETHUPANDI, Singapore (SG); Gil Lampong OPINA, JR., Singapore (SG)

(21) Appl. No.: 19/437,858

(22) Filed: Dec. 31, 2025

Related U.S. Application Data
(60) Provisional application No. 63/741,566, filed on Jan. 3, 2025.

(51) Int. Cl. H02M 1/36; H02M 3/22

(52) U.S. Cl. CPC H02M 1/36; H02M 3/22

(57) ABSTRACT

A system for precharging a converter includes precharge circuitry having low voltage switches to regulate precharge energy flow from an energy source to a low voltage side of the converter. The converter includes converter circuitry. The converter circuitry includes a grid connection switch and a medium voltage link capacitor coupled to a medium voltage side of the converter. The system includes interfaces to communicate with the precharge circuitry or with the converter circuitry. The controller circuitry performs regulating switching statuses of the low voltage switches based on a precharge circuitry attribute or a converter circuitry attribute. In response to the switching statuses being ON, for each converter cell, the controller circuitry selects between an open or closed loop mode of regulation based on a link voltage across the medium voltage link capacitor. The closed loop mode includes switching the low voltage switches OFF and connecting the converter to a grid.

### CROSS REFERENCE TO RELATED APPLICATION

This application claims the benefit of and priority to U.S. Provisional Patent Application No. 63/741,566, filed Jan. 3, 2025, entitled “Low Voltage Side Pre-Charging Technique of Medium Voltage DC Link Capacitor Bank for Solid-State Transformer,” the content of which is incorporated herein by reference in its entirety.

### TECHNICAL FIELD

This disclosure pertains to electronic controlling of converters such as solid state transformers (SSTs).

### BACKGROUND

Power electronics provide a newfound resiliency to the energy infrastructure. For example, power electronics integrate different energy sources, such as renewable energy sources, into the electric grid. The power electronics themselves need to be electrically compatible with the electric grid in order to be stably and safely integrated into the grid. One aspect of electrical compatibility is precharging capacitive components within the power electronics before connecting to the grid. Precharging prevents inrush currents into the power electronics while maintaining grid stability upon integration.

### SUMMARY

A converter, including its capacitive elements, is to be precharged prior to integration of the converter with the electric grid in order to mitigate potential detrimental consequences. If not precharged, one detrimental consequence includes inrush currents due to previously uncharged capacitor elements trying to charge from the full grid voltage. Inrush currents may damage the capacitive elements, cause mechanical shock or other failure to switches or circuit breakers, and trip protection devices due to overcurrent conditions. Another detrimental consequence includes causing grid disturbance due to voltage sags, harmonics, or transient voltage drops, which may impact other electrical components connected to the electric grid. Yet another detrimental consequence includes failed synchronization of the converter, which may encompass an instable or unmatched voltage output of the converter compared to the electric grid. Failed synchronization may result in transient power flows, uncontrolled oscillations, or instability of the converter.

A claimed solution rooted in electronic technology overcomes problems such as the aforementioned problems specifically arising in the realm of electronic technology by implementing a lightweight system to precharge a converter prior to integration with the electric grid. A converter precharging system is configured to program precharging of a converter from a low voltage side of the converter to enhance electrical compatibility of a converter with the electric grid prior to integration with the electric grid. The converter precharging system may confer additional benefits including monitoring or predicting a health status of converter cells.

The converter precharging system may include a precharge control system and a converter control system. The precharge control system includes precharge circuitry, which includes switches configured to switch ON or OFF to adjust a status (e.g., on or off status) or an amount of precharge (e.g., current or voltage) to a converter. In some embodiments, the switches include relays or contactors. The switches may include low voltage switches, which may operate in a low voltage range of up to 1000 Volts of alternating current (AC) or up to 1500 Volts of direct current (DC). Implementing low voltage switches results in conserved space and increased overall power density, as well as smaller components of the downstream converter.

The switches may include a series switch connected in series with a downstream resistor and a shunt switch connected in parallel with the resistor. The series switch may be configured to regulate whether or not precharging occurs, while the parallel switch may be configured to regulate an amount of precharge once the series switch is closed.

The precharge control system includes a precharge controller configured to control the switching states of the precharge circuitry. Controlling the switching states causes the precharge circuitry to selectively precharge the converter and synchronize precharging of the converter with one or more sensed conditions at the precharge circuitry or at the converter. Examples of sensed conditions may include one or more bus voltages across bus capacitors or link voltages across link capacitors, one or more bus voltages across bus capacitors, or temperatures of converter components. If the precharge controller determines that a switch should be ON, the precharge controller may generate and transmit a signal to a corresponding driver which may energize a coil to close the switch. If the precharge controller determines, or obtains an indication that the switch should be OFF, the precharge controller may generate and transmit a signal to a corresponding driver which may de-energize the coil to open the switch.

The converter precharging system may include a converter control system. The converter control system includes converter circuitry and a converter controller. The converter circuitry may include, for example, a solid state transformer (SST). The converter circuitry may be configured to transform and distribute energy from one or more energy storage components to one or more loads that draw energy from the energy storage components. The converter controller may be configured to control link voltages across one or more bus capacitors or link capacitors (e.g., capacitors connected to one or more converter components such as inverters). The converter controller may implement different control modes to control the link voltages. For example, the converter controller may be configured to implement an open loop control by sending a command to a low voltage inverter to adjust an inverter output (e.g., a duty cycle or phase shift) which causes a link voltage across a medium voltage link capacitor to increase. When the link voltage reaches a threshold link voltage, the converter controller may implement a closed loop control by continuously synchronizing the link voltages according to instantaneous link voltages or other conditions. In some embodiments, the converter circuitry may include multiple converter cells. The converter controller may be configured to synchronize the link voltages among the multiple converter cells, for example, to make the link voltages uniform. Once the link voltages across one or more converter cells have been synchronized, or reach a grid threshold voltage, then the converter controller may close a grid connection switch to integrate the converter circuitry with the electric grid. In some embodiments, the converter controller may program the switches within the precharge circuitry to open.

The converter controller may be configured to monitor a health status of the converter circuitry based on one or more inflow currents. For example, the converter controller may be configured to detect an inflow current profile of inflow current into the low voltage inverter, relative to an amount of precharge (e.g., a bus voltage or a link voltage across a low voltage bus capacitor or a medium voltage link capacitor). If the converter controller detects that over time, the inflow current at a given amount of precharge has decreased, then the converter controller may identify that the converter circuitry health has deteriorated.

According to various embodiments of the disclosed technology is a system for precharging a converter. The system comprises precharge circuitry comprising one or more low voltage switches to regulate precharge energy flow from an energy source to a low voltage side of a converter, the converter including converter circuitry, the converter circuitry including a grid connection switch and a medium voltage link capacitor coupled to a medium voltage side of the converter. The controller system includes one or more interfaces configured to communicate with the precharge circuitry or with the converter circuitry of the converter. The controller system includes controller circuitry configured to perform: obtaining a precharge circuitry attribute corresponding to the precharge circuitry; obtaining a converter circuitry attribute corresponding to the converter circuitry; regulating one or more switching statuses of the one or more low voltage switches based on the precharge circuitry attribute or on the converter circuitry attribute; in response to the one or more switching statuses of the one or more low voltage switches corresponding to an ON status, for each converter cell corresponding to the converter circuitry: obtaining a controller circuitry attribute, the controller circuitry attribute corresponding to a link voltage across the medium voltage link capacitor coupled to the medium voltage side; based on the controller circuitry attribute, selecting between an open loop mode and a closed loop mode of regulating the link voltage; and in response to selecting the closed loop mode: switching the one or more switching statuses of the one or more low voltage switches to an OFF status; and switching a switching status of the grid connection switch to an ON status to connect the converter to an electric grid.

In some embodiments, the converter circuitry further comprises a low voltage bus capacitor coupled to a low voltage side, the low voltage side corresponding to a low voltage inverter, the low voltage bus capacitor being upstream relative to the medium voltage link capacitor with respect to a direction of the precharge energy flow, and the regulating one or more switching statuses of the one or more low voltage switches is based on the converter circuitry attribute, the converter circuitry attribute corresponding to a bus voltage across the low voltage bus capacitor.

In some embodiments, the one or more low voltage switches comprise a series switch and a shunt switch downstream of the series switch, the series switch being connected in parallel with a resistor and the shunt switch being connected in parallel with the resistor; and regulating one or more switching statuses of the low voltage switches comprises: in response to the bus voltage being less than a threshold bus voltage, switching the series switch to an ON status and switching the shunt switch to an OFF status; and in response to the bus voltage exceeding the threshold bus voltage, switching the series switch to an ON status and switching the shunt switch to an ON status.

In some embodiments, selecting between an open loop mode and a closed loop mode of regulating the link voltage comprises: in response to the link voltage being less than a threshold link voltage, selecting an open loop mode; and in response to the link voltage exceeding the threshold link voltage, selecting the closed loop mode.

In some embodiments, the converter comprises a first converter cell and a second converter cell, the medium voltage link capacitor comprises a first medium voltage link capacitor, the link voltage comprises a first link voltage, the first converter cell comprises the first medium voltage link capacitor and the second converter cell comprises a second medium voltage link capacitor; and the closed loop mode comprises selectively adjusting the first link voltage based on a second link voltage across the second medium voltage link capacitor.

In some embodiments, the closed loop mode comprises selectively adjusting the link voltage to be within a threshold link voltage range.

In some embodiments, the open loop mode comprises programming a low voltage side within the converter circuitry to ramp up a duty ratio of an AC waveform.

In some embodiments, the open loop mode comprises programming a low voltage side within the converter circuitry to ramp up a duty ratio of an AC waveform.

In some embodiments, the closed loop mode comprises selectively activating an auxiliary winding to generate additional magnetic flux based on the link voltage.

In some embodiments, the controller circuitry is further configured to perform: generating a medium voltage alternating current (AC) waveform in response to selecting the closed loop mode; comparing the medium voltage AC waveform to one or more electrical attributes of the electric grid; and in response to the medium voltage AC waveform conforming to the one or more electrical attributes of the electric grid, switching the switching status of the grid connection switch to an ON status.

In some embodiments, the converter comprises a first converter cell and a second converter cell, the first converter cell comprises a first low voltage side, the second converter cell comprises a second low voltage side; and the controller circuitry is further configured to perform: monitoring a first health status of the first converter cell based on a first inflow current profile of a first inflow current into the first low voltage side; monitoring a second health status of the second converter cell based on a second inflow current profile of a second inflow current into the second low voltage side; and selectively triggering an alarm or deactivating the first converter cell or the second converter cell based on the first health status or the second health status.

According to various embodiments of the disclosed technology is a method for precharging a converter implemented by controller circuitry within a controller system of an electric system, the electric system comprising precharge circuitry comprising one or more low voltage switches to regulate precharge energy flow from an energy source to a low voltage side of a converter, the converter comprising converter circuitry, the converter circuitry including a grid connection switch and a medium voltage link capacitor coupled to a medium voltage side of the converter, the controller system comprising a controller and one or more interfaces communicating with the precharge circuitry or with the converter circuitry of the converter. The method comprises: obtaining a precharge circuitry attribute corresponding to the precharge circuitry; obtaining a converter circuitry attribute corresponding to the converter circuitry; regulating one or more switching statuses of the one or more low voltage switches based on the precharge circuitry attribute or on the converter circuitry attribute; in response to the one or more switching statuses of the one or more low voltage switches corresponding to an ON status, for each converter cell corresponding to the converter circuitry: obtaining a controller circuitry attribute, the controller circuitry attribute corresponding to a link voltage across the medium voltage link capacitor coupled to the medium voltage side; based on the controller circuitry attribute, selecting between an open loop mode and a closed loop mode of regulating the link voltage; and in response to selecting the closed loop mode: switching the one or more switching statuses of the one or more low voltage switches to an OFF status; and switching a switching status of the grid connection switch to an ON status to connect the converter to an electric grid.

### BRIEF DESCRIPTION OF THE DRAWINGS

FIG. 1 is a diagram of an example converter precharging system, illustrating a mechanism of precharging a converter prior to integrating the converter into an electric grid, according to some embodiments.

FIG. 2 is a diagram of an example precharge control system, according to some embodiments.

FIG. 3 is a diagram of an example converter control system, according to some embodiments.

FIG. 4 is a flowchart illustrating an example precharge control method, according to some embodiments.

FIG. 5 is a flowchart illustrating an example converter control method, according to some embodiments.

FIG. 6 is an example capacitor precharging diagram, according to some embodiments.

FIG. 7 is an example precharging current monitoring diagram, according to some embodiments.

### DETAILED DESCRIPTION

A converter, including its capacitive elements, is to be precharged prior to integration of the converter with the electric grid in order to mitigate potential detrimental consequences. If not precharged, one detrimental consequence includes inrush currents due to previously uncharged capacitor elements trying to charge from the full grid voltage. Inrush currents may damage the capacitive elements, cause mechanical shock or other failure to switches or circuit breakers, and trip protection devices due to overcurrent conditions. Another detrimental consequence includes causing grid disturbance due to voltage sags, harmonics, or transient voltage drops, which may impact other electrical components connected to the electric grid. Yet another detrimental consequence includes failed synchronization of the converter, which may encompass an instable or unmatched voltage output of the converter compared to the electric grid. Failed synchronization may result in transient power flows, uncontrolled oscillations, or instability of the converter.

A claimed solution rooted in electronic technology overcomes problems such as the aforementioned problems specifically arising in the realm of electronic technology by implementing a lightweight manner to precharge a converter prior to integration with the electric grid. A converter precharging system is configured to program precharging of a converter from a low voltage side of the converter to enhance electrical compatibility of a converter with the electric grid prior to integration with the electric grid. The converter precharging system may confer additional benefits including monitoring or predicting a health status of converter cells.

The converter precharging system may include a precharge control system and a converter control system. The precharge control system includes precharge circuitry, which includes switches configured to switch ON or OFF to adjust a status (e.g., on or off status) or an amount of precharge (e.g., current or voltage) to a converter. In some embodiments, the switches include relays or contactors. The switches may include low voltage switches, which may operate in a low voltage range of up to 1000 Volts of alternating current (AC) or up to 1500 Volts of direct current (DC). Implementing low voltage switches results in conserved space and increased overall power density, as well as smaller components of the downstream converter.

The switches may include a series switch connected in series with a downstream resistor and a shunt switch connected in parallel with the resistor. The series switch may be configured to regulate whether precharging occurs, while the parallel switch may be configured to regulate an amount of precharge once the series switch is closed.

The precharge control system includes a precharge controller configured to control the switching states of the precharge circuitry. Controlling the switching states causes the precharge circuitry to selectively precharge the converter and synchronize precharging of the converter with one or more sensed conditions at the precharge circuitry or at the converter. Examples of sensed conditions may include one or more bus voltages across bus capacitors, link voltages across link capacitors or temperatures of converter components. If the precharge controller determines that a switch should be ON, the precharge controller may generate and transmit a signal to a corresponding driver which may energize a coil to close the switch. If the precharge controller determines, or obtains an indication that the switch should be OFF, the precharge controller may generate and transmit a signal to a corresponding driver which may de-energize the coil to open the switch.

The converter precharging system may include a converter control system. The converter control system includes converter circuitry and a converter controller. The converter circuitry may include, for example, a solid state transformer (SST). The converter circuitry may be configured to transform and distribute energy from one or more energy storage components to one or more loads that draw energy from the energy storage components. The converter controller may be configured to control link voltages across one or more link capacitors (e.g., capacitors connected to one or more converter components such as inverters). The converter controller may implement different control modes to control the link voltages. For example, the converter controller may be configured to implement an open loop control by sending a command to a low voltage inverter to adjust an inverter output (e.g., a duty cycle or phase shift) which causes a link voltage across a medium voltage link capacitor to increase. When the link voltage reaches a threshold link voltage, the converter controller may implement a closed loop control by continuously synchronizing the link voltages according to instantaneous link voltages or other conditions. In some embodiments, the converter circuitry may include multiple converter cells. The converter controller may be configured to synchronize the link voltages among the multiple converter cells, for example, to make the link voltages uniform. Once the link voltages across one or more converter cells have been synchronized, or reach a grid threshold voltage, then the converter controller may close a grid connection switch to integrate the converter circuitry with the electric grid. In some embodiments, the converter controller may program the switches within the precharge circuitry to open.

The converter controller may be configured to monitor a health status of the converter circuitry based on one or more inflow currents. For example, the converter controller may be configured to detect an inflow current profile of inflow current into the low voltage inverter, relative to an amount of precharge (e.g., a bus voltage across a low voltage bus capacitor or a link voltage across a medium voltage link capacitor). If the converter controller detects that over time, the inflow current at a given amount of precharge has decreased, then the converter controller may identify that the converter circuitry health has deteriorated.

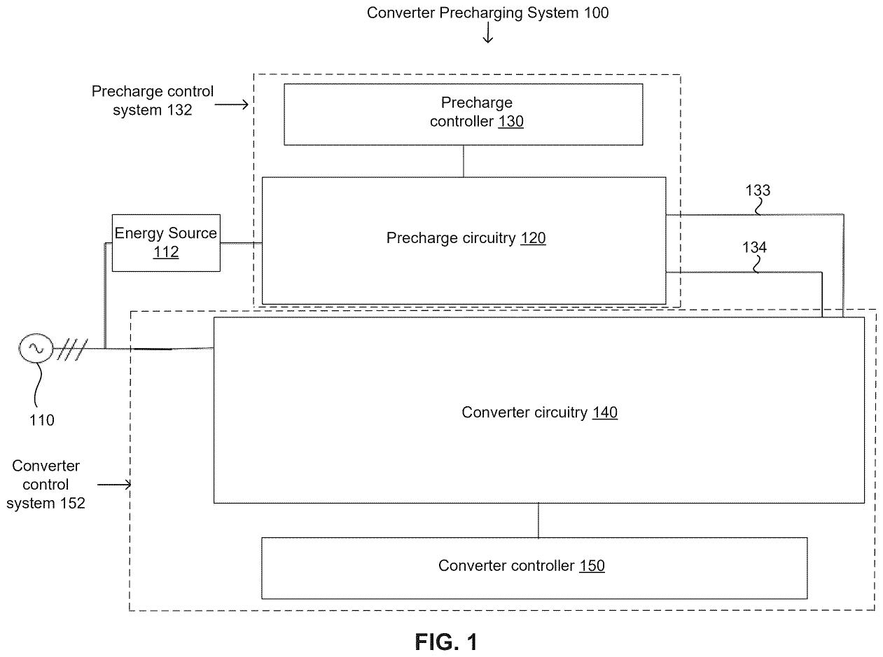

FIG. 1 is a diagram of an example converter precharging system 100, illustrating a mechanism of precharging a converter prior to integrating the converter into an electric grid, according to some embodiments. The converter precharging system 100 may include a precharge control system 132 and a converter control system 152. In some embodiments, the converter precharging system 100 includes a bus (e.g., characterized by bus terminals 133, 134). In some embodiments, the converter precharging system 100 includes the energy source 112. In other embodiments, the converter precharging system 100 does not include the energy source 112, which is supplied externally.

The precharge control system 132 may include precharge circuitry 120, which includes switches configured to switch ON or OFF to adjust a status (e.g., ON or OFF status) or an amount of precharge (e.g., inflow current or link voltage) to a converter (e.g., converter circuitry 140). In some embodiments, the switches include relays or contactors. The switches may include low voltage switches, which may operate in a low voltage range of up to 1000 Volts of alternating current (AC) or up to 1500 Volts of direct current (DC). Implementing low voltage switches, as opposed to medium voltage switches, results in conserved space and increased overall power density, as well as smaller components of the downstream converter.

In some embodiments, an initial, or deenergized status of the switches is OFF, corresponding to an open state of the switches. The switches may include a series switch connected in series with a downstream resistor and a shunt switch connected in parallel with the resistor. The series switch may be configured to regulate turning ON or OFF of the precharge, while the parallel switch may be configured to regulate an amount of precharge once the series switch is closed. In some embodiments, the energy source 112 connected to the precharge circuitry 120 may supply precharging energy that precharges the converter circuitry 140. The energy source 112 may include one or more batteries, supercapacitors, renewable energy sources such as photovoltaics, chargers, generators, motors, substations, or other energy sources. The energy source 112 may include an alternating current (AC) energy source or have an inverter configured to convert direct current (DC) energy to AC energy. When one or more of the switches are closed, precharge energy from the energy source 112 flows through the precharge circuitry 120 through the bus and to the converter circuitry 140. The precharge energy may initially supply an inflow current to a low voltage side, such as to a low voltage inverter. The precharge energy may initially increase a bus voltage of one or more low voltage bus capacitors linked to the low voltage inverter before increasing a link voltage of one or more medium voltage link capacitors linked to a medium voltage inverter.

The precharge control system 132 includes a precharge controller 130 configured to control the switching states of the precharge circuitry 120. Controlling the switching states causes the precharge circuitry 120 to selectively precharge the converter circuitry 140 and synchronize precharging of the converter circuitry 140 with one or more sensed conditions at the precharge circuitry 120 or at the converter circuitry 140. Examples of sensed conditions may include one or more bus voltages across bus capacitors or link voltages across link capacitors or temperatures of converter components. For example, other sensed conditions may include temperature or pulse parameters of the resistor. If the precharge controller 130 determines that a switch should be ON, the precharge controller 130 may generate and transmit a signal to a corresponding driver which may energize a coil within a solenoid to close the switch. If the precharge controller 130 determines, or obtains an indication that the switch should be OFF, the precharge controller 130 may generate and transmit a signal to a corresponding driver which may de-energize the coil to open the switch.

The precharge controller 130 may include software, hardware, or firmware to control the precharge circuitry 120. In some embodiments, the precharge controller 130 may include one or more processors that read and/or write instructions (e.g., which may include parameters, expressions, protocols, evaluations, conditions, arguments, and/or functions) to implement the control of the operations. These operations may include receiving communications from the precharge circuitry 120, the converter circuitry 140, converter controller 150, or from one or more sensors, and transmitting communications to the precharge circuitry 120, the converter circuitry 140, the converter controller 150, via one or more interfaces. The communications may be transmitted over a network. In some embodiments, the precharge controller 130 may be configured to generate signals that cause circuitry to be programmed in a specific manner, such as generating signals to one or more drivers that cause coils within the switches to be activated or energized. Relevant principles described above for the precharge controller 130 may also apply to the converter controller 150.

The converter control system 152 includes the converter circuitry 140 and a converter controller 150. The converter circuitry 140 may include, for example, a solid state transformer (SST). The converter circuitry 140 may be configured to transform and distribute energy from one or more energy storage components to one or more loads that draw energy from the energy storage components. The converter controller 150 may be configured to control link voltages across one or more link capacitors which may be connected to one or more converter components such as inverters (e.g., low voltage inverters or medium voltage inverters). The converter controller 150 may implement different control modes to control the link voltages. For example, the converter controller 150 may initially be configured to implement an open loop control by sending a command to a low voltage inverter to adjust an inverter output (e.g., a duty cycle or phase shift) which causes a link voltage across a medium voltage link capacitor to increase. When the link voltage reaches a threshold link voltage, the converter controller 150 may implement a closed loop control by continuously synchronizing the link voltages according to instantaneous link voltages or other conditions. In some embodiments, the converter circuitry may include multiple converter cells. The converter controller 150 may be configured to synchronize the link voltages among the multiple converter cells, for example, to make the link voltages uniform. Once the link voltages across one or more converter cells have been synchronized, or reach a grid threshold voltage, then the converter controller 150 may program closing of a grid connection switch within the converter circuitry 140. Closing the grid connection switch may establish a connection between the electric grid 110 (e.g., a medium voltage electric grid) and a medium voltage (MV) side of the converter circuitry 140. In some embodiments, the converter controller 150 may program the switches within the precharge circuitry 120 to open in order to terminate precharging.

The converter controller 150 may be configured to monitor a health status of the converter circuitry 140 based on one or more inflow currents. For example, the converter controller 140 may be configured to detect an inflow current profile of inflow current into the low voltage inverter, relative to an amount of precharge (e.g., a bus voltage across a low voltage bus capacitor or a link voltage across a medium voltage link capacitor). If the converter controller 140 detects that over time, the inflow current at a given amount of precharge has decreased, then the converter controller may identify that the converter circuitry health has deteriorated because the ability to precharge has decreased.

In some embodiments, the converter precharging system 100 may include any subset of the components shown in FIG. 1. For example, the converter precharging system 100 may include the precharge control system 132. As another example, the converter precharging system 100 may include the precharge control system 132 and the converter controller 150. In some embodiments, the precharge control system 132 and the converter control system 152 may be integrated into a single control system. In some embodiments, the precharge controller 130 and the converter controller 150 may be integrated into a single controller.

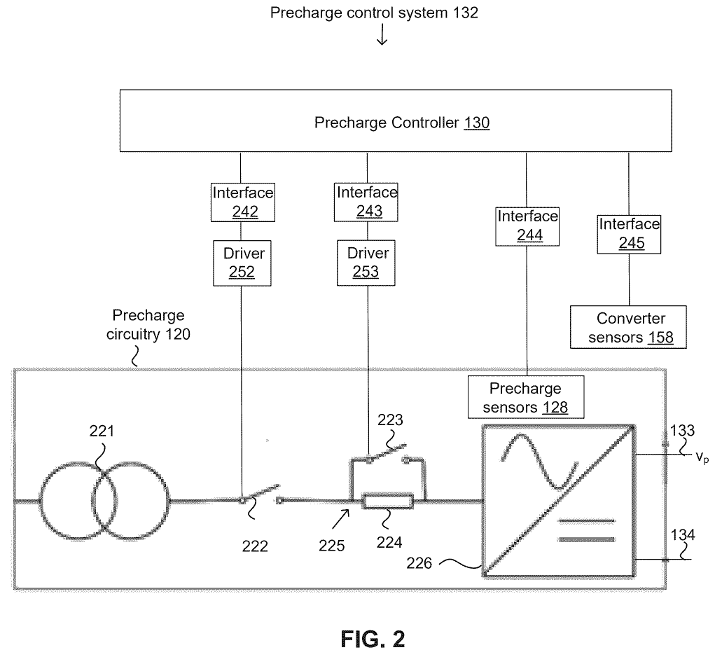

FIG. 2 is a diagram of an example precharge control system 132, according to some embodiments. As indicated in FIG. 1, the precharge control system 132 includes the precharge circuitry 120 and the precharge controller 130. The precharge circuitry 120 may include a transformer 221 such as an auxiliary transformer configured to step down a voltage from the energy source 112. Downstream of the transformer 221, a low voltage switch assembly may regulate whether or not the precharge energy from the energy source 112 is transmitted to the downstream converter circuitry 140, or an amount of the precharge energy transmitted. The low voltage switch assembly may include one or more low voltage switches to regulate precharge energy flow from the energy source 112 to a low voltage side of a converter (e.g., low voltage bus capacitor 302 of converter cell 301 or low voltage inverter 303 of converter cell 301, or other corresponding low voltage bus capacitors or low voltage inverters of other converter cells). For example, the low voltage switch assembly may include a series switch 222 in series with a resistor 224, and a shunt switch 223 in parallel with the resistor 224. In some embodiments, the shunt switch 223 and the resistor 224 constitute shunt switch circuitry 225. A rectifier 226 may transmit AC energy from the shunt switch circuitry 225 to DC energy. A bus, which may include bus terminals 133, 134, may transmit the AC energy from the rectifier 226 to the converter circuitry 140. The bus terminals 133, 134 may constitute positive and negative terminals, respectively.

In some embodiments, the series switch 222 and the shunt switch 223 are OFF, or open, in a default state. In some embodiments, the series switch 222 is configured to close before the shunt switch 223 closes. When the series switch 222 is open and the shunt switch 223 is closed, a limited amount of precharge energy is transmitted through a resistor path that includes the resistor 224. When an amount of precharge energy reaches a threshold precharge energy, the shunt switch 223 may be configured to close. Determining whether the precharge energy reaches a threshold may include obtaining one or more electrical measurements at the precharge circuitry 120 or the converter circuitry 140. For example, the precharge energy may be measured according to a voltage output Vₚ at an output of the rectifier 226, or one or more link voltages V₁₁ or one or more inflow currents Iₚ. The sequential closing of the series switch 222 and the shunt switch 223 implements two stages or phases of precharging, an initial gradual precharging phase when the series switch 222 is open and the shunt switch 223 is closed and a faster precharging phase when both the series switch 222 and the shunt switch 223 are closed.

Within the precharge circuitry 120, or within a vicinity (e.g., a threshold distance) of the precharge circuitry 120 may be one or more precharge sensors 128 that may output one or more signals indicative of one or more operational conditions associated with the precharge circuitry 120. The one or more signals may include, correspond to, or be used to derive precharge circuitry attributes. The operational conditions may include one or more voltages such as the voltage output Vₚ or voltage across other precharge circuitry components, one or more currents across one or more precharge circuitry components, a temperature or other environmental condition such as humidity. For example, operational conditions may include temperature or pulse parameters of the resistor 224.

The precharge controller 130 may be configured to obtain the one or more signals from the precharge sensors 128 (e.g., precharge circuitry attributes) or signals from one or more converter sensors 158 within the converter circuitry 140 via one or more interfaces 244 or 245, respectively. In some embodiments, signals from the converter sensors 158 may include, correspond to, or be used to derive one or more converter circuitry attributes. Any interfaces implemented across any figures (e.g., the interfaces 244, 245 or other interfaces) may communicate sensor signals from the precharge sensors 128 or from the converter sensors 158, state information or status updates, such as status of obtained sensor data, or operational statuses of the precharge circuitry 120, the converter circuitry 140, or the converter controller 150. In some embodiments, any interfaces may be configured via control signals and/or user interfaces as needed. Any interfaces may be configured to convert commands from the precharge controller 130 into signals. For example, the precharge controller 130 may transmit commands requesting certain sensor data. The interfaces 244 or 245 may translate these commands into specific actions to convert signals from the precharge sensors 128 or from the converter sensors 158 into sensor data. The precharge controller 130 may be configured to regulate one or more switching statuses of the low voltage switch assembly based on one or more precharge circuitry attributes or based on one or more converter circuitry attributes.

In some embodiments, the precharge controller 130 may be configured to program one or more drivers 252, 253 via one or more interfaces 242, 243, respectively. For example, if the precharge controller 130 determines that the series switch 222 should be ON, or otherwise obtains an indication to turn ON the series switch 222, the precharge controller 130 may generate and transmit an ON signal to the interface 242. The interface 242 may convert the ON signal to an executable command to the driver 252. The driver 252 may execute the command to energize a coil within the series switch 222 to cause the series switch 222 to close. Likewise, if the precharge controller 130 determines that the shunt switch 223 should be ON, after the precharge threshold has been reached, the precharge controller 130 may generate and transmit an ON signal to the interface 243. The interface 243 may convert the ON signal to an executable command to the driver 253. The driver 253 may execute the command to energize a coil within the shunt switch 223 to cause the shunt switch 223 to close. Conversely, if the precharge controller 130 determines that one or both the series switch 222 or the shunt switch 223 should be OFF, the precharge controller 130 may generate and transmit an OFF signal to the interface 242 or 243. The interface 242 or 243 may convert the OF signal to an executable command to the driver 252 or 253, which in turn deenergizes a coil within the series switch 222 or the shunt switch 223. Additional or fewer interfaces, and additional or fewer drivers may be implemented. In some embodiments, the interfaces or the drivers may or may not be part of the precharge control system 132.

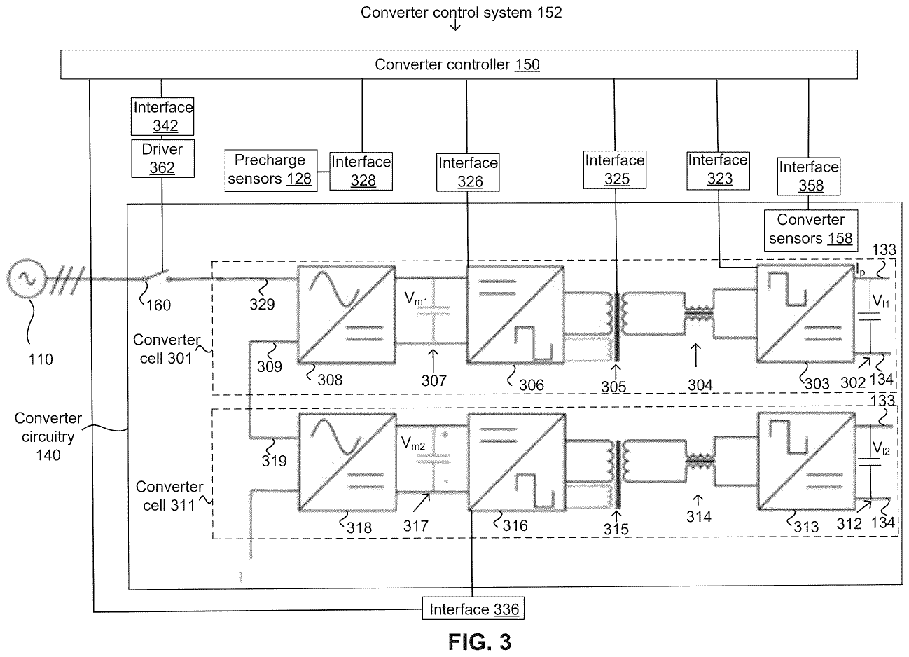

FIG. 3 is a diagram of an example converter control system 152, according to some embodiments. As previously indicated, the converter control system 112 includes the converter circuitry 140 and the converter controller 150. In some embodiments, the converter circuitry 140 includes converter cells 301, 311 which may be connected in series across their respective medium voltage links or terminals 309, 319. In some embodiments, each converter cell may handle only a fraction of the total grid voltage from the electric grid 110. In a scenario with two converter cells, each converter cell may handle only a half of the total grid voltage. In a scenario with n converter cells, each converter cell may handle only 1/n of the total grid voltage. Although two converter cells 301, 311 are shown in FIG. 3, the converter circuitry 140 may include any number of converter cells, including a scenario with only one converter cell.

The converter cell 301 may include a low voltage bus capacitor 302, which may be precharged at a voltage of V₁₁ with an inflow current of Iₚ during precharging. In some embodiments, the low voltage bus capacitor 302 may be part of, or be coupled to, the low voltage side of the converter that receives the precharge energy flow from the energy source 112. In some embodiments, the converter may correspond to, or include, the converter circuitry 140. The low voltage bus capacitor 302 may be connected to a low voltage inverter 303 which converts low voltage DC energy to high-frequency AC energy. The low voltage inverter 303 may be connected to a transformer 304, such as a high frequency isolation transformer to step up AC voltage. The transformer 304 may include an auxiliary winding 305 which may include a transformer winding that is used to supply additional energy in some situations. In some embodiments, the auxiliary winding 305 may be supplied from a low voltage AC source. In some embodiments, the auxiliary winding 305 is configured to generate an additional magnetic flux when activated. The transformer 304 may be connected to a medium voltage rectifier 306, which converts high frequency AC energy to DC energy. The medium voltage rectifier 306 may be connected to a medium voltage link capacitor 307, which may have a precharge link voltage of Vₘ₁. The medium voltage link capacitor 307 may stabilize the medium voltage link 309, 329 while absorbing current fluctuations. In some embodiments, the medium voltage link capacitor 307 may be implemented as a capacitor bank. In some embodiments, the medium voltage link capacitor 307 is coupled to a medium voltage side of the converter. In some embodiments, the medium voltage link capacitor is coupled to a medium voltage side of the capacitor. The medium voltage link capacitor 307 may be connected to an inverter 308 which converts DC energy to AC energy, in order for the energy to be transmitted to the electric grid 110 via medium voltage link 329. Other implementations of the converter cell 301 are also possible such as a converter cell having a rectifier, a DC-DC converter, and an inverter.

The converter cell 311 may be implemented in a similar or analogous manner as the converter cell 301. The converter cell 311 may include a low voltage bus capacitor 312, which may be precharged at a voltage of V₁₂ with an inflow current of Iₚ during precharging. The low voltage bus capacitor 312 may be connected to a low voltage inverter 313 which converts low voltage DC energy to high-frequency AC energy. The low voltage inverter 313 may be connected to a transformer 314, such as a high frequency isolation transformer to step up AC voltage. The transformer may include an auxiliary winding 315 which may include a transformer winding that is used to supply additional energy in some situations. In some embodiments, the auxiliary winding 315 may be supplied from a low voltage AC source. The transformer 314 may be connected to a medium voltage rectifier 316, which converts high frequency AC energy to DC energy. The medium voltage rectifier 316 may be connected to a medium voltage link capacitor 317, which may have a precharge link voltage of Vₘ₂. The medium voltage link capacitor 317 may stabilize the medium voltage link 319 while absorbing current fluctuations. In some embodiments, the medium voltage link capacitor 317 may be implemented as a capacitor bank. In some embodiments, the medium voltage link capacitor 317 is connected to an inverter 318 which converts DC energy to AC energy.

The converter controller 150 may be configured to obtain the one or more signals from the precharge sensors 128 or from the converter sensors 158 within the converter circuitry 140 via one or more interfaces 328 or 358, respectively. The signals may include or be indicative of one or more operational conditions within the converter circuitry 140 or the precharge circuitry 120. The signals may include or be indicative of voltage, such as one or more link voltages Vₘ₁ or Vₘ₂, bus voltages V₁₁ or V₁₂, currents such as inflow current Iₚ, loading conditions, or environmental conditions such as temperature or humidity.

The converter controller 150 may program different modes of controlling one or more precharging attributes within the converter circuitry 140. For example, the converter controller 150 may be configured to regulate a link voltage Vₘ₁ of the link capacitor 307 via either an open loop approach or a closed loop approach, responsive to one or more switching statuses of the one or more low voltage switches corresponding to an ON status. In some embodiments, the converter controller 150 regulates the link voltage Vₘ₁ based on a converter circuitry attribute. In some embodiments, the converter controller 150 regulates the link voltage Vₘ₁ initially via an open loop approach, as long as the link voltage is below a threshold link voltage. Once the converter controller 150 detects, or obtains an indication that the link voltage has reached the threshold link voltage, the converter controller 150 may regulate the link voltage by the closed loop approach. In some embodiments, the converter controller 150 is configured to transmit an open loop regulation signal, via an interface 323, to the low voltage inverter 303 to adjust an inverter output (e.g., a duty cycle or phase shift) which causes a link voltage across a medium voltage link capacitor to increase. In some embodiments, when the link voltage reaches a threshold link voltage, the converter controller 150 is configured to transmit a closed loop regulation signal, via an interface 306, to the medium voltage rectifier 306 to implement closed loop link voltage regulation in which link voltage is continuously or dynamically adjusted based on instantaneous link voltages. In some embodiments, closed loop link voltage regulation includes continuously synchronizing the link voltages Vₘ₁, Vₘ₂ among different converter cells according to instantaneous link voltages or other conditions. In some embodiments, the converter controller 150 is configured to transmit an activation signal to the auxiliary winding 305, via an interface 325, to implement closed loop link voltage regulation. In some embodiments, interfaces across different converter cells such as the converter cell 311 may be implemented in a same or similar manner. For example, the converter controller 150 may be configured to communicate with interface 336 to transmit a closed loop regulation signal to the medium voltage rectifier 316.

In some embodiments, the converter controller 150 is configured to program a driver 362, via an interface 342, to switch the grid connection switch 360 ON or OFF. For example, once the link voltage Vₘ₁ reaches a grid threshold voltage, or the link voltages among different converter cells have been sufficiently synchronized, the converter controller 150 is configured to transmit a grid connection signal to the interface 342. The interface 342 may in turn transmit an executable command to the driver 362. The driver 362 may energize a coil within a grid connection switch 160 to cause the grid connection switch 160 to close.

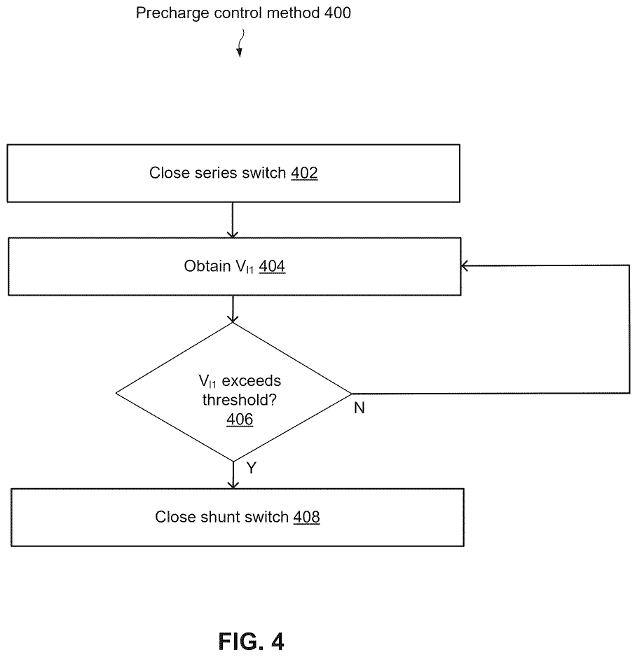

FIG. 4 is a flowchart illustrating an example precharge control method 400, according to some embodiments. The precharge control method 400 may be implemented by the precharge control system 132. The precharge controller 130 may, in step 402, detect that precharging is to be performed, or otherwise receive an indication to precharge. In response to detecting that precharging is to be performed, the precharge controller 130 may close the series switch 122. Closing the series switch results in a limited amount of precharge energy from the energy source 112, through the transformer 121, past the closed series switch 122, and through the resistor 124. In step 404, the precharge controller 130 may obtain an indication of an extent of precharging that has been performed. The extent of precharging may be identified, for example, by a bus voltage V₁₁ across the low voltage bus capacitor 302. The bus voltage V₁₁ may include an instantaneous value of bus voltage or time series data of bus voltage over a period of time. In some examples, additionally or alternatively, the extent of precharging may be identified by the voltage Vₚ. In decision 406, the precharge controller 130 may determine whether the extent of precharging exceeds a threshold extent or otherwise satisfies other precharging criteria. For example, the precharge controller 130 may determine whether the bus voltage V₁₁ exceeds a threshold bus voltage. If the bus voltage V₁₁ exceeds the threshold bus voltage, the precharge controller 130 may close the shunt switch 223 in step 408. Upon closing the shunt switch, a larger amount of precharge energy may be transmitted to the converter circuitry 140, because the precharge energy may flow through a path defined by the closed shunt switch 223 instead of through the resistor 224. If the bus voltage V₁₁ is less than the threshold bus voltage or equal to the threshold bus voltage, the precharge controller 130 may continue to obtain an indication of an extent of precharging that has been performed, until the extent of precharging exceeds the threshold extent.

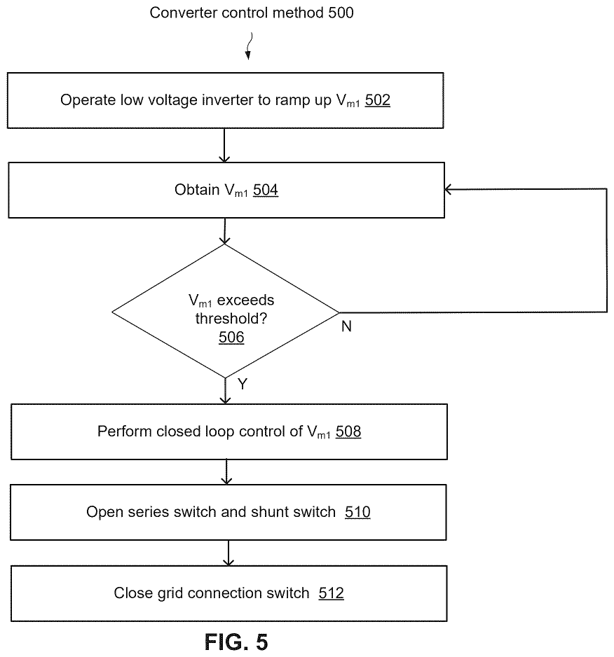

FIG. 5 is a flowchart illustrating an example converter control method 500, according to some embodiments. The converter control method 500 may be implemented by the converter control system 152, or by both the converter control system 152 and the precharge control system 132. The converter control method 500 may follow the precharge control method 400. The converter control method 500 may include perform at least part of steps 502, 504, 506, and 508 on each individual converter cell 301, 311. That is, each individual cell 301, 311 may be precharged individually at different times. In some embodiments, at least some of the individual cells may be precharged at different times relative to one another. As described, the converter control method 500 focuses on the converter cell 301. Same or similar steps may be performed for different converter cells such as the converter cell 311 or other converter cells.

The converter controller 150 may, in step 502, operate the low voltage inverter 303 to regulate one or more inverter attributes such as regulating (e.g., ramping up) a duty cycle of a high frequency AC waveform. The converter controller 502 may transmit one or more open loop activation signals, for example, to the interface 323 to activate open loop control in the low voltage inverter 303. Ramping up the duty cycle may cause the Vₘ₁ to ramp up. Step 502 may constitute open loop control. In step 504, the converter controller 150 may obtain or determine a value of Vₘ₁. The determined value of Vₘ₁ may include an instantaneous value or time series data of Vₘ₁ over a period of time. In decision 506, the converter controller 150 may determine whether Vₘ₁ exceeds a link voltage threshold or otherwise satisfies a link voltage criteria or other criteria. If the converter controller 150 determines that Vₘ₁ exceeds a link voltage threshold, the converter controller 150 may activate closed loop regulation of Vₘ₁ in step 508. Activating closed loop regulation may include transmitting one or more closed loop activation signals to one or more interfaces such as interfaces 326, 325, in order to cause the rectifier 306 or the auxiliary winding 305 to regulate Vₘ₁ based on instantaneous values of Vₘ₁. In some embodiments, closed loop regulation may include ensuring that Vₘ₁ conforms to a link voltage range.

In some embodiments, the aforementioned steps 502, 504, 506, 508 may be repeated across different converter cells. In some embodiments, closed loop regulation encompasses maintaining same or similar link voltages across different converter cells. In step 510, when closed loop regulation is being implemented, precharging is no longer needed. Thus, the converter controller 150 may transmit a signal to the precharge controller 130 to open the shunt switch 123 and the series switch 122. In some embodiments, the shunt switch 123 may be opened before the series switch 122. In step 512, the converter controller 150 may cause the grid connection switch 160 to close in order to integrate the converter circuitry 140 with the electric grid 110. In some embodiments, prior to closing the grid connection switch 160, the converter controller may generate a medium voltage AC waveform that is synchronized to the grid voltage to ensure electrical compatibility with the electric grid 110.

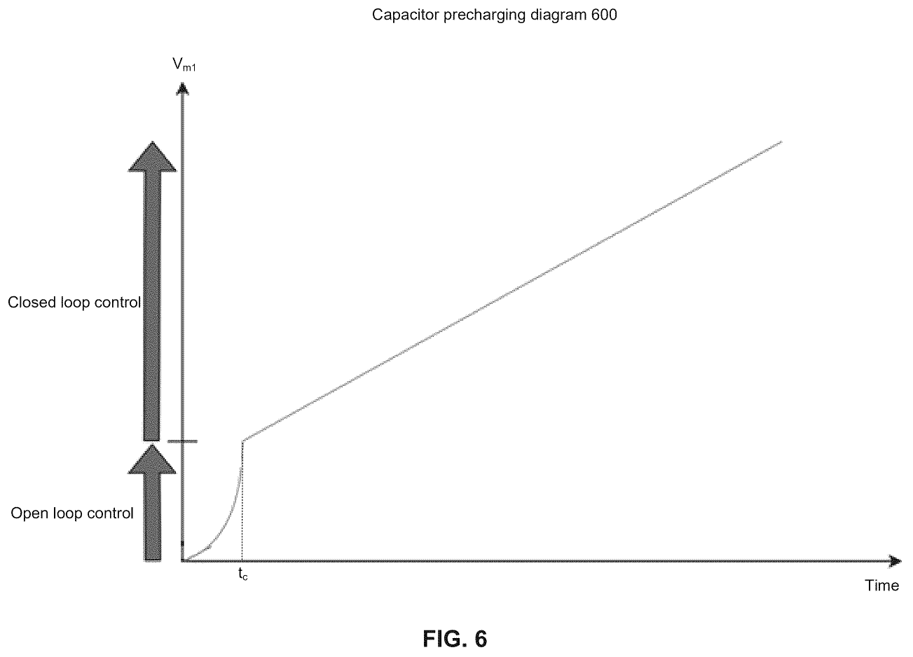

FIG. 6 illustrates a capacitor precharging diagram 600. The capacitor precharging diagram 600 illustrates a relationship between link voltage Vₘ₁ over time, as open loop control and closed loop control are implemented. In some embodiments, time to corresponds to the time at which closed loop control is triggered due to Vₘ₁ exceeding a link voltage threshold. At time t_{c}, regulation of Vₘ₁ is switched from open loop control, for example regulated by the low voltage inverter 303, to closed loop control, for example regulated by the medium voltage rectifier 306 or by the auxiliary windings 305. During the open loop control, link voltage Vₘ₁ may increase nonlinearly, based on an exponential or power relationship over time. During the closed loop control, link voltage Vₘ₁ may increase linearly over time, or more linearly over time compared to the open loop control.

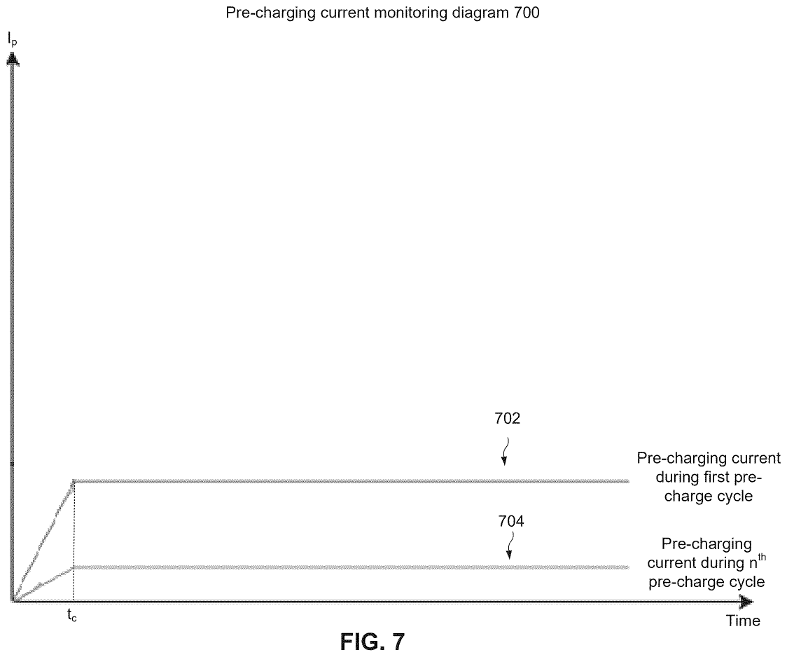

FIG. 7 illustrates a precharging current monitoring diagram 700. The precharging current monitoring diagram 700 illustrates a relationship 702 of a precharging current (e.g., inflow current Iₚ) over time during a first precharge cycle or initial precharge cycles. The precharging current monitoring diagram 700 illustrates a relationship 704 of a precharging current over time during an n^{th} precharge cycle following the initial precharge cycles. The relationship 704 exhibits a decreased precharging current, compared to the relationship 702, at same precharge levels. For example, at a given value of Vₘ₁, Iₚ may be lower after n cycles of precharge compared to initial cycles of precharge. The link voltages over time may be the same no matter if the precharge is a first precharge cycle or an n^{th} precharge cycle. Assuming a constant link voltage profile, the precharging current profile may exhibit a smaller precharging current after n cycles of precharge which may suggest degradation of one or more converter cells. Degradation of converter cells may be attributed to increased equivalent series resistance of MVDC-link capacitors, degraded bonding wires in power semiconductors, or corrosion in contact points.

If the converter controller 150 detects or predicts at least a threshold level of degradation which may correspond to at least a threshold amount or percent of precharging current decrease, the converter controller 150 may trigger an alarm. Additionally or alternatively, the converter controller 150 may be configured to deactivate a converter cell for which at least a threshold level of degradation has been predicted.

In some embodiments, relationship data including link voltages over time and precharging current over time may be used as training data to train a machine learning component, in order to detect which precharging current profiles may indicate degradation and which precharging current profiles do not indicate degradation. A trained machine learning component may generate outputs corresponding to a predicted degradation status, including whether or not a converter cell has been degraded or an extent of degradation.

Controllers may communicate with one another, or with interfaces, via a network. The network may include any secured communication network such as an encrypted network. The network may represent one or more computer networks (e.g., LAN, WAN, or the like) or other transmission mediums. In some embodiments, the network includes one or more computing devices, routers, cables, buses, and/or other network topologies (e.g., mesh, and the like). In some embodiments, the network may be wired and/or wireless. In various embodiments, the network may include the Internet, one or more wide area networks (WANs) or local area networks (LANs), one or more networks that may be public, private, IP-based, non-IP based, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Any reference to “approximate,” “near,” “threshold,” “sufficiency,” “uniform,” may be construed to encompass any applicable value or degree, such as any applicable value or degree sufficient to satisfy a given outcome, such as a value of link voltage that is sufficient to safely connect with an electric grid. In some examples, a threshold level, similarity or degree thereof may be construed to include any values such as 99.9 percent, 99.75 percent, 99.5 percent, 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to disclose the scenario of A “or” B. Reference to A “or” B may be construed to disclose the scenario of A “and” B.

The present technologies are described above with reference to example embodiments. It will be apparent to those skilled in the art that various modifications may be made and other embodiments may be used without departing from the broader scope of the present technologies. Therefore, these and other variations upon the example embodiments are intended to be covered by the present technologies.

1. A system for precharging a converter, the system comprising:
precharge circuitry comprising one or more low voltage switches to regulate precharge energy flow from an energy source to a low voltage side of a converter, the converter including converter circuitry, the converter circuitry including a grid connection switch and a medium voltage link capacitor coupled to a medium voltage side of the converter; and
a controller system comprising:
one or more interfaces configured to communicate with the precharge circuitry or with the converter circuitry of the converter;
controller circuitry configured to perform:
obtaining a precharge circuitry attribute corresponding to the precharge circuitry;
obtaining a converter circuitry attribute corresponding to the converter circuitry;
regulating one or more switching statuses of the one or more low voltage switches based on the precharge circuitry attribute or on the converter circuitry attribute;
in response to the one or more switching statuses of the one or more low voltage switches corresponding to an ON status, for each converter cell corresponding to the converter circuitry:
obtaining a controller circuitry attribute, the controller circuitry attribute corresponding to a link voltage across the medium voltage link capacitor coupled to the medium voltage side;
based on the controller circuitry attribute, selecting between an open loop mode and a closed loop mode of regulating the link voltage; and
in response to selecting the closed loop mode:
switching the one or more switching statuses of the one or more low voltage switches to an OFF status; and
switching a switching status of the grid connection switch to an ON status to connect the converter to an electric grid.

2. The system of claim 1, wherein the converter circuitry further comprises a low voltage bus capacitor coupled to a low voltage side, the low voltage side corresponding to a low voltage inverter, the low voltage bus capacitor being upstream relative to the medium voltage link capacitor with respect to a direction of the precharge energy flow, and the regulating one or more switching statuses of the one or more low voltage switches is based on the converter circuitry attribute, the converter circuitry attribute corresponding to a bus voltage across the low voltage bus capacitor.

3. The system of claim 2, wherein the one or more low voltage switches comprise a series switch and a shunt switch downstream of the series switch, the series switch being connected in parallel with a resistor and the shunt switch being connected in parallel with the resistor; and regulating one or more switching statuses of the low voltage switches comprises:
in response to the bus voltage being less than a threshold bus voltage, switching the series switch to an ON status and switching the shunt switch to an OFF status; and
in response to the bus voltage exceeding the threshold bus voltage, switching the series switch to an ON status and switching the shunt switch to an ON status.

4. The system of claim 1, wherein selecting between an open loop mode and a closed loop mode of regulating the link voltage comprises:
in response to the link voltage being less than a threshold link voltage, selecting an open loop mode; and
in response to the link voltage exceeding the threshold link voltage, selecting the closed loop mode.

5. The system of claim 1, wherein the converter comprises a first converter cell and a second converter cell, the medium voltage link capacitor comprises a first medium voltage link capacitor, the link voltage comprises a first link voltage, the first converter cell comprises the first medium voltage link capacitor and the second converter cell comprises a second medium voltage link capacitor; and the closed loop mode comprises selectively adjusting the first link voltage based on a second link voltage across the second medium voltage link capacitor.

6. The system of claim 1, wherein the closed loop mode comprises selectively adjusting the link voltage to be within a threshold link voltage range.

7. The system of claim 1, wherein the open loop mode comprises programming a low voltage side within the converter circuitry to ramp up a duty ratio of an AC waveform.

8. The system of claim 1, wherein the closed loop mode comprises selectively activating an auxiliary winding to generate additional magnetic flux based on the link voltage.

9. The system of claim 1, wherein the controller circuitry is further configured to perform:
generating a medium voltage alternating current (AC) waveform in response to selecting the closed loop mode;
comparing the medium voltage AC waveform to one or more electrical attributes of the electric grid; and
in response to the medium voltage AC waveform conforming to the one or more electrical attributes of the electric grid, switching the switching status of the grid connection switch to an ON status.

10. The system of claim 1, wherein the converter comprises a first converter cell and a second converter cell, the first converter cell comprises a first low voltage side, the second converter cell comprises a second low voltage side; and the controller circuitry is further configured to perform:
monitoring a first health status of the first converter cell based on a first inflow current profile of a first inflow current into the first low voltage side;
monitoring a second health status of the second converter cell based on a second inflow current profile of a second inflow current into the second low voltage side; and
selectively triggering an alarm or deactivating the first converter cell or the second converter cell based on the first health status or the second health status.

11. A method for precharging a converter implemented by controller circuitry within a controller system of an electric system, the electric system comprising precharge circuitry comprising one or more low voltage switches to regulate precharge energy flow from an energy source to a low voltage side of a converter, the converter comprising converter circuitry, the converter circuitry including a grid connection switch and a medium voltage link capacitor coupled to a medium voltage side of the converter, the controller system comprising a controller and one or more interfaces communicating with the precharge circuitry or with the converter circuitry of the converter, the method comprising:
obtaining a precharge circuitry attribute corresponding to the precharge circuitry;
obtaining a converter circuitry attribute corresponding to the converter circuitry;
regulating one or more switching statuses of the one or more low voltage switches based on the precharge circuitry attribute or on the converter circuitry attribute;
in response to the one or more switching statuses of the one or more low voltage switches corresponding to an ON status, for each converter cell corresponding to the converter circuitry:
obtaining a controller circuitry attribute, the controller circuitry attribute corresponding to a link voltage across the medium voltage link capacitor coupled to the medium voltage side;
based on the controller circuitry attribute, selecting between an open loop mode and a closed loop mode of regulating the link voltage; and
in response to selecting the closed loop mode:
switching the one or more switching statuses of the one or more low voltage switches to an OFF status; and
switching a switching status of the grid connection switch to an ON status to connect the converter to an electric grid.

12. The method of claim 11, wherein the converter circuitry further comprises a low voltage bus capacitor coupled to a low voltage side, the low voltage side corresponding to a low voltage inverter, the low voltage bus capacitor being upstream relative to the medium voltage link capacitor with respect to a direction of the precharge energy flow, and the regulating one or more switching statuses of the one or more low voltage switches is based on the converter circuitry attribute, the converter circuitry attribute corresponding to a bus voltage across the low voltage bus capacitor.

13. The method of claim 12, wherein the one or more low voltage switches comprise a series switch and a shunt switch downstream of the series switch, the series switch being connected in parallel with a resistor and the shunt switch being connected in parallel with the resistor; and regulating one or more switching statuses of the low voltage switches comprises:
in response to the bus voltage being less than a threshold bus voltage, switching the series switch to an ON status and switching the shunt switch to an OFF status; and
in response to the bus voltage exceeding the threshold bus voltage, switching the series switch to an ON status and switching the shunt switch to an ON status.

14. The method of claim 11, wherein selecting between an open loop mode and a closed loop mode of regulating the link voltage comprises:
in response to the link voltage being less than a threshold link voltage, selecting an open loop mode; and
in response to the link voltage exceeding the threshold link voltage, selecting the closed loop mode.

15. The method of claim 11, wherein the converter comprises a first converter cell and a second converter cell, the medium voltage link capacitor comprises a first medium voltage link capacitor, the link voltage comprises a first link voltage, the first converter cell comprises the first medium voltage link capacitor and the second converter cell comprises a second medium voltage link capacitor; and the closed loop mode comprises selectively adjusting the first link voltage based on a second link voltage across the second medium voltage link capacitor.

16. The method of claim 11, wherein the closed loop mode comprises selectively adjusting the link voltage to be within a threshold link voltage range.

17. The method of claim 11, wherein the open loop mode comprises programming a low voltage side within the converter circuitry to ramp up a duty ratio of an AC waveform.

18. The method of claim 11, wherein the closed loop mode comprises selectively activating an auxiliary winding to generate additional magnetic flux based on the link voltage.

19. The method of claim 11, further comprising:
generating a medium voltage alternating current (AC) waveform in response to selecting the closed loop mode;
comparing the medium voltage AC waveform to one or more electrical attributes of the electric grid; and
in response to the medium voltage AC waveform conforming to the one or more electrical attributes of the electric grid, switching the switching status of the grid connection switch to an ON status.

20. The method of claim 11, wherein the converter comprises a first converter cell and a second converter cell, the first converter cell comprises a first low voltage side, the second converter cell comprises a second low voltage side; and the method further comprises:
monitoring a first health status of the first converter cell based on a first inflow current profile of a first inflow current into the first low voltage side;
monitoring a second health status of the second converter cell based on a second inflow current profile of a second inflow current into the second low voltage side; and
selectively triggering an alarm or deactivating the first converter cell or the second converter cell based on the first health status or the second health status.
